(19) United States
(12) Patent Application Publication
(10) Pub. No.: US 2018/0044979 A1
(43) Pub. Date: Feb. 15, 2018

(54) WINDOW CURTAIN CONTROL DEVICE

(71) Applicants: SHENG YING HSU, Changhua County (TW); CHUN JAN HSU, Changhua County (TW)

(72) Inventors: SHENG YING HSU, Changhua County (TW); CHUN JAN HSU, Changhua County (TW)

(21) Appl. No.: 15/667,973

(22) Filed: Aug. 3, 2017

(30) Foreign Application Priority Data
Aug. 9, 2016 (TW) 105212014

(51) Int. Cl. E06B 9/323; E06B 9/262; A47H 3/08; E06B 9/322

(52) U.S. Cl. CPC E06B 9/323; E06B 9/322; E06B 9/262; A47H 3/08

(57) ABSTRACT

A window curtain control device includes a top box having a room therein, and a fixed part and a scrolling member are respectively positioned on two ends of the room. A curtain is connected to the top box, and a bottom rail is connected to the lower end of the curtain. A movable part is movably located between the fixed part and the scrolling member. A tension rope has one end fixed to the fixed part, and the other end of the tension rope wraps around the fixed part and the movable part. A driving rope has one end fixed to the movable part and the other end of the driving rope includes an operation portion which extends through the top box. The curtain is moved by operating the operation portion.

### BACKGROUND OF THE INVENTION

### 1. Fields of the Invention

The present invention relates to a window curtain control device, and more particularly, to a window curtain control device that is operated with less effort to control lifting or lowering movement of the window curtain.

### 2. Descriptions of Related Art

The conventional window curtain control devices are disclosed in U.S. Pat. No. 7,398,815 and U.S. Pat. No. 7,487,817. Both of the patents discloses a top box, a curtain and a bottom rail, wherein the curtain is located between the top box and the bottom rail, and the bottom rail is connected to the lower end of the curtain. A scrolling member and a fixed part are respectively located in the top box. A movable part is movably located between the fixed part and the scrolling member. The driving rope has one end fixed to the movable part and the other end extends through the top box. The tension rope has one end fixed to the fixed part, and the other end wraps around the fixed part and the movable part. When the bottom rail is pushed upward or pulled downward, the driving rope and the tension rope are cooperated to each other to lift or lower the curtain.

However, when the curtain is positioned at a higher position where the bottom rail is located at the higher position, the user may not easily hold the bottom rail and controls the curtain. Besides, the position that the curtain is moved cannot be precisely controlled by simply moving the bottom rail.

The present invention intends to provide a window curtain control device which has an operation portion extending from the driving rope which is easily operated, and the operation portion does not wrap children playing around.

### SUMMARY OF THE INVENTION

The present invention relates to a window curtain control device and comprises a top box having a room therein, and a fixed part and a scrolling member are respectively positioned on two ends of the room. A curtain is connected to the top box, and a bottom rail is connected to the lower end of the curtain. A movable part is movably located between the fixed part and the scrolling member. A tension rope has one end fixed to the fixed part, and the other end of the tension rope wraps around the fixed part and the movable part. A driving rope has one end fixed to the movable part and the other end of the driving rope includes an operation portion which extends through the top box. The curtain is moved by operating the operation portion.

The advantages of the present invention are that the curtain is moved by operating the operation portion of the driving rope.

The operation portion is a hanging section of the driving rope which has simplified structure and does not wrap children.

The tension rope wraps around the movable part eight laps while the driving rope wraps around the movable part one lap, such that when the operation portion is moved one centimeter, the curtain moves eight centimeters.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 shows the top box of the curtain control device of the present invention;

FIG. 2 shows the fixed part, the movable part and the scrolling member in the top box of the curtain control device of the present invention;

FIG. 3 is a partial cross sectional view to show the curtain control device of the present invention installed to a window curtain, and

FIG. 4 shows that when the operation portion is pulled, the curtain lifts.

### DETAILED DESCRIPTION OF THE PREFERRED EMBODIMENT

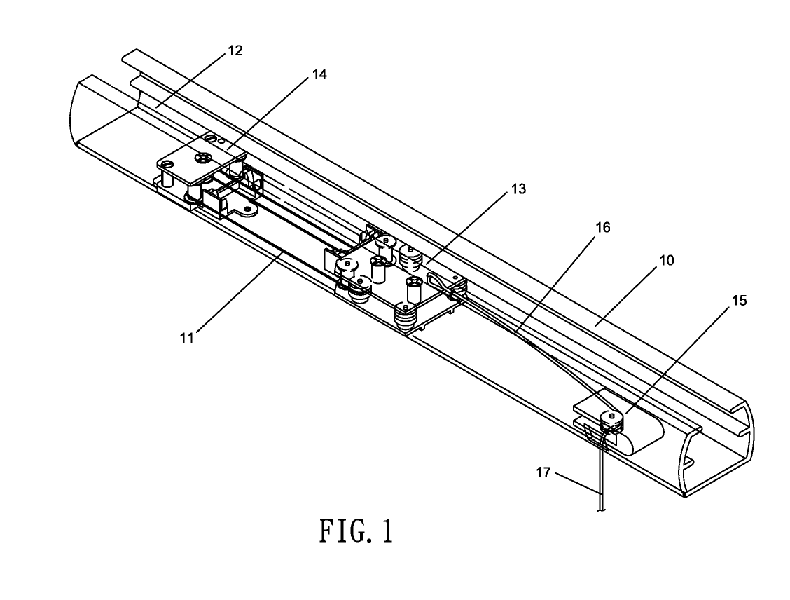

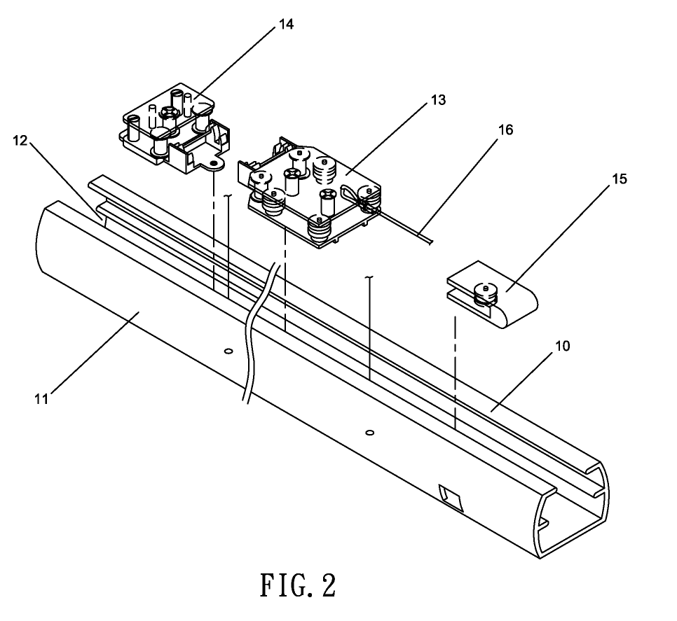

Referring to FIGS. 1 to 4, the window curtain control device of the present invention comprises a top box 10, and a curtain is connected to the top box 10. A bottom rail 20 is connected to the lower end of the curtain. The top box 10 includes a room 12 defined therein. A fixed part 14 and a scrolling member 15 are respectively positioned on two ends of the room 12. A movable part 13 is movably located between the fixed part 14 and the scrolling member 15.

A tension rope 11 has one end fixed to the fixed part 14, and the other end of the tension rope 11 wraps around the fixed part 14 and the movable part 13, and extends through the top box 10 and connected to the bottom rail 20. A driving rope 16 has one end fixed to the movable part 13 and the other end of the driving rope 16 extends through the top box 10 and comprises an operation portion 17 which is a section of the driving rope 16 and hangs below the top box 10. The curtain is moved by operating the operation portion 17. The operation portion 17 has a handle 18 connected to the distal end thereof. The tension rope 11 wraps around the movable part 13 eight laps while the driving rope 16 wraps around the movable part 13 one lap.

The users operates the operation portion 17 to control the movement of the curtain, and this is convenient for the users.

As shown in FIGS. 1, 3 and 4, the operation portion 17 is a section of the driving rope 16 and hangs below the top box 10. The operation portion 17 is simple and does not wrap children playing around.

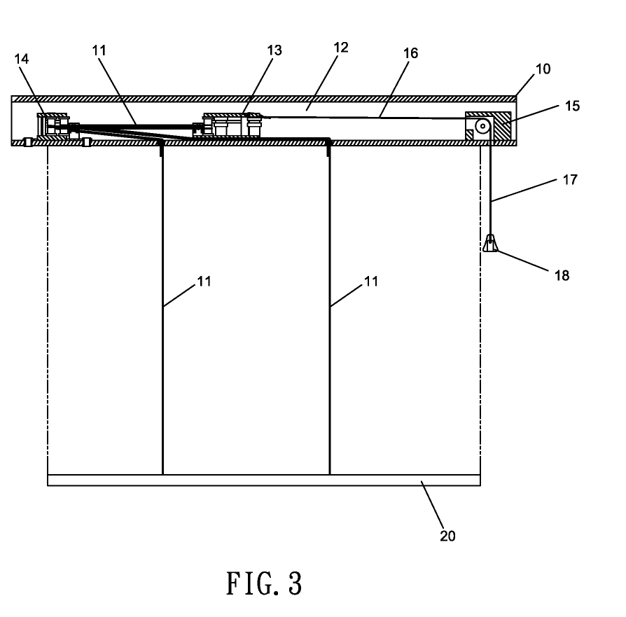

As shown in FIG. 3, when the users want to lower the curtain, the operation portion 17 is pushed upward, the tension of the operation portion 17 is loosened, and the movable part 13 moves toward the fixed part 14. The tension rope 11 lowered, and the curtain and the bottom rail 20 are lowered due to gravity.

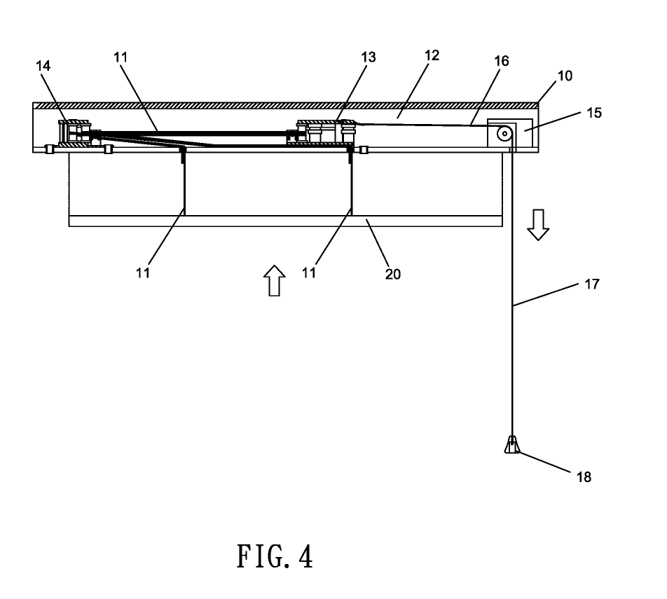

As shown in FIG. 4, when the users want to lift the curtain, the operation portion 17 is pulled downward, the movable part 13 moves away from the fixed part 14, and the tension rope 11 is lifted to lift the curtain.

The handle 18 is designed for convenience of operation to the operation portion 17.

The operation portion 17 has a handle 18 connected to the distal end thereof. The tension rope 11 wraps around the movable part 13 eight laps while the driving rope 16 wraps around the movable part 13 one lap. Therefore, when the operation portion 17 is moved one centimeter, the curtain moves eight centimeters. This saves effort of the users.

While we have shown and described the embodiment in accordance with the present invention, it should be clear to those skilled in the art that further embodiments may be made without departing from the scope of the present invention.

What is claimed is:

1. A window curtain control device comprising a top box, a curtain connected to the top box, and a bottom rail, the bottom rail connected to a lower end of the curtain, the top box having a room defined therein, wherein:
a fixed part and a scrolling member are respectively positioned on two ends of the room, a movable part is movably located between the fixed part and the scrolling member, a tension rope has one end fixed to the fixed part, and the other end of the tension rope wraps around the fixed part and the movable part, a driving rope has one end fixed to the movable part and the other end of the driving rope extends through the top box and comprises an operation portion, the curtain is moved by operating the operation portion.

2. The window curtain control device as claimed in claim 1, wherein the operation portion is a section of the driving rope and hangs below the top box.

3. The window curtain control device as claimed in claim 1, wherein the operation portion has a handle connected thereto.

4. The window curtain control device as claimed in claim 1, wherein the tension rope wraps around the movable part eight laps while the driving rope wraps around the movable part one lap.
